(19) United States
(12) Patent Application Publication
(10) Pub. No.: US 2016/0319770 A1
(43) Pub. Date: Nov. 3, 2016

(54) VALVE COVER ASSEMBLY

(71) Applicant: Electro-Motive Diesel, Inc., LaGrange, IL (US)

(72) Inventors: Amar Jeetendra Panchangam Nivarthi, Darien, IL (US); Michael B. Goetzke, Orland Park, IL (US); Robert T. MacVicar, Downers Grove, IL (US); Nicholas Shim-Ping, Mount Prospect, IL (US); Jeffrey P. Nowak, Munster, IN (US)

(73) Assignee: Electro-Motive Diesel, Inc., LaGrange, IL (US)

(21) Appl. No.: 14/699,534

(22) Filed: Apr. 29, 2015

(51) Int. Cl. F02F 7/00

(52) U.S. Cl. CPC F02F 7/006; F02F 7/0021

(57) ABSTRACT

A valve cover assembly for an engine is provided. The valve cover assembly includes a housing configured to receive a portion of a valve train of the engine. The housing includes a top closed end and a bottom open end. The valve cover also includes a front window provided on a top wall and a front facing wall of the housing. The valve cover further includes a front cover releasably coupled to the front window. The front cover is configured to provide selective access to components of the valve train present inside the housing. The valve cover includes a side window provided on the top wall and a side facing wall of the housing. The valve cover further includes a side cover releasably coupled to the side window. The side cover is configured to provide selective access to the components of the valve train present inside the housing.

### TECHNICAL FIELD

The present disclosure relates to a valve cover assembly, and more particularly to a valve cover assembly for a valve train of an engine.

### BACKGROUND

Internal Combustion (IC) engines, such as, a four-stroke IC engine include a valve train for operation of valves in order to control timing and quantity of gas flow into engine cylinders and removal of exhaust products therefrom. The valves are generally opened and closed by a camshaft that is synchronized to the crankshaft by a chain, belt, or gear. The camshaft actuates a valve lifter which in turn actuates the valve stem through a push rod and a rocker arm.

Components of the valve train become contaminated by foreign particles, such as, dirt or dust from outside environment. Hence, the components are enclosed within a housing. Further, a removal and installation of the housing is carried out several times during a life cycle of the engine, for maintenance and servicing of the valve train. During the removal of the housing, high pressure fuel lines connected to the housing may have to be uprooted, and also the sealing between the housing and associated mating surfaces may get disturbed. Further, the installation of the housing may also be a tedious, laborious, and costly process.

U.S. Pat. No. 6,591,930 describes a motorcycle engine capable of being supported within a frame. The engine includes a cylinder head having an upper peripheral edge and a valve cover having an assembled width and a lower peripheral edge substantially corresponding in shape to the upper peripheral edge of the cylinder head. The valve cover includes first and second portions coupled together along an engagement surface that does not extend across the entire assembled width of the valve cover. The second portion is separable from the first portion along the engagement surface to facilitate removal of the first portion from the engine.

### SUMMARY OF DISCLOSURE

In one aspect of the present disclosure, a valve cover assembly for an engine is provided. The valve cover assembly includes a housing defining an interior space therewithin. The housing is configured to receive a portion of a valve train of the engine. The housing includes a top closed end and a bottom open end, wherein the bottom open end is coupled to a surface of the engine. The valve cover also includes a front window provided on a top wall and a front facing wall of the housing. The valve cover further includes a front cover releasably coupled to the front window. The front cover is configured to provide selective access to components of the valve train present inside the housing. The valve cover includes a side window provided on the top wall and a side facing wall of the housing. The valve cover further includes a side cover releasably coupled to the side window. The side cover is configured to provide selective access to the components of the valve train present inside the housing.

In yet another aspect of the present disclosure, a valve cover assembly for an engine is provided. The valve cover assembly includes a housing defining an interior space therewithin. The housing is configured to receive a portion of a valve train of the engine. The housing includes a top closed end and a bottom open end, wherein the bottom open end is coupled to a surface of the engine. The valve cover assembly also includes a front window provided on a top wall and a front facing wall of the housing. The valve cover assembly further includes a front cover releasably coupled to the front window; the front cover is configured to provide selective access to components of the valve train present inside the housing. The valve cover assembly includes a rear window provided on the top wall and a rear facing wall of the housing. The valve cover assembly further includes a rear cover releasably coupled to the rear window. The rear cover is configured to provide selective access to the components of the valve train present inside the housing.

In yet another aspect of the present disclosure, a method for servicing of a valve train of an engine is provided. The method includes providing at least one of a rear window or a side window on a housing of a valve cover assembly. The method also includes coupling, releasably, a corresponding rear cover or a side cover with the housing. The method further includes accessing the components of the valve train through the at least one of the rear window or the side window based on the coupling.

Other features and aspects of this disclosure will be apparent from the following description and the accompanying drawings.

### BRIEF DESCRIPTION OF THE DRAWINGS

FIG. 1 is a perspective view of a portion of an engine provided with a valve cover assembly, according to one embodiment of the present disclosure;

FIG. 2 is a perspective exploded view of the valve cover assembly, according to one embodiment of the present disclosure;

FIG. 3 is a perspective exploded view of the valve cover assembly, according to another embodiment of the present disclosure; and

FIG. 4 is a method of servicing of a valve train of the engine.

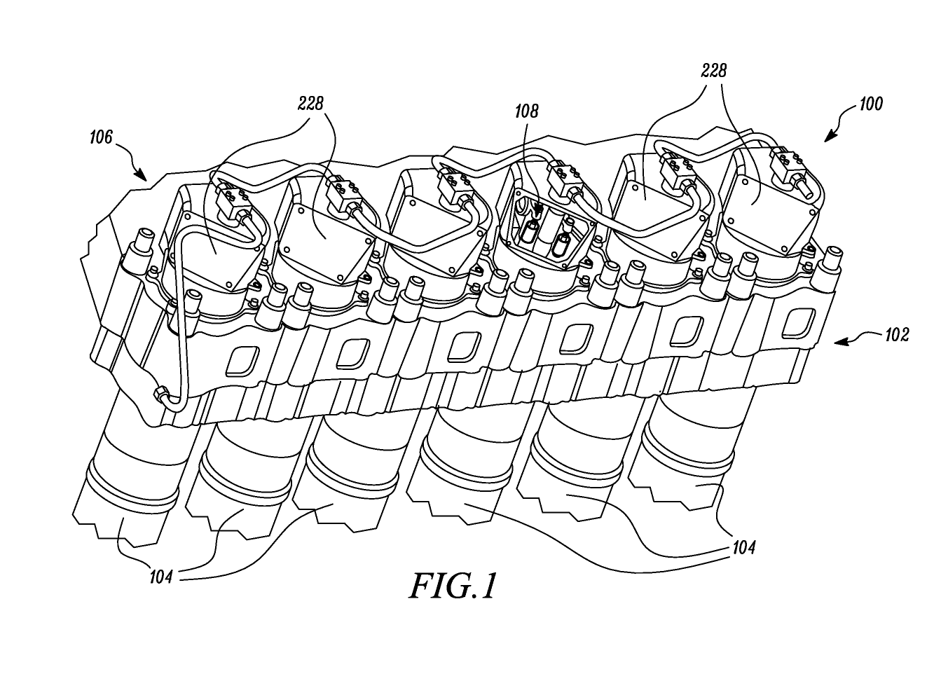

### DETAILED DESCRIPTION

Wherever possible, the same reference numbers will be used throughout the drawings to refer to the same or the like parts. FIG. 1 illustrates a portion of an exemplary engine 100, according to one embodiment of the present disclosure. In one embodiment, the engine 100 includes a diesel powered engine. In other embodiments, the engine 100 may include any Internal Combustion (IC) engine known in the art including, but not limited to, a gasoline powered engine, a natural gas powered engine, or a combination thereof. The engine 100 includes a cylinder head 102 and a cylinder block (not shown). The cylinder block may include a plurality of cylinders 104. In the illustrated embodiment, the engine 100 is a six cylinder engine. However, the number of cylinders may vary, without limiting the scope of the present disclosure.

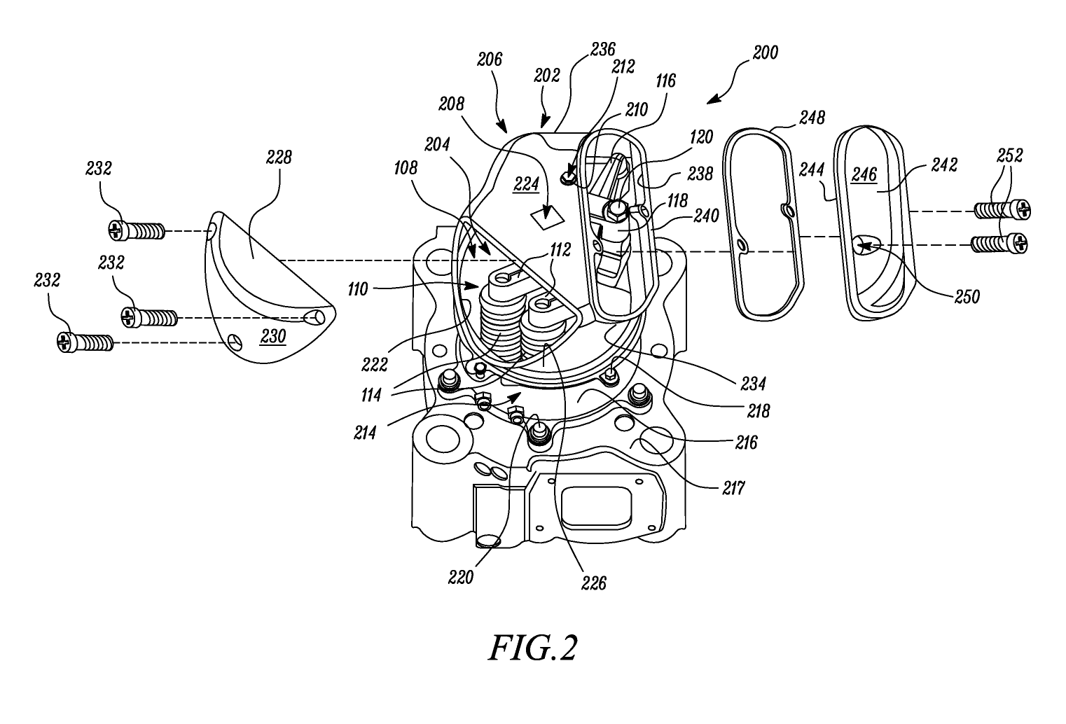

Further, a valve train assembly 106 is associated with the engine 100. The valve train assembly 106 may include a plurality of valve trains 108 (see FIG. 2). In the illustrated embodiment, the valve train assembly 106 includes six valve trains 108 corresponding to the number of cylinders 104. The valve train 108 may include one or more valves 110, for example, an intake valve or an exhaust valve. The intake and exhaust valves may be configured to open and close an intake port (not shown) and an exhaust port (not shown) of the cylinders 104 respectively, in order to control air and gas flow into and out of the cylinders 104, thereby facilitating combustion. The valves 110 disclosed herein may be any known valve, for example, a poppet valve. The valve 110 may include a valve stem 112 and a valve spring 114. The valve 110 is retained normally in the closed position by means of the valve spring 114.

The valve train 108 also includes a camshaft (not shown), a tappet (not shown), a push-rod (not shown) and a rocker arm 116. The camshaft may be disposed within the cylinder head 102 of the engine 100. Alternatively, the camshaft may be disposed within the cylinder block of the engine 100. The camshaft may be configured to operate the tappet of the valve train 108, followed by the push rod, the rocker arm 116, and thereafter the valves 110.

As shown in FIG. 2, the valve train 108 may be enclosed within a valve cover assembly 200. Each valve train 108 includes a corresponding valve cover assembly 200 associated therewith (see FIG. 1). The valve cover assembly 200 is configured to isolate the valve train 108 from the outside environment. Moreover, the valve cover assembly 200 protects the valve train 108 from dust, dirt, and other foreign materials that may contaminate or cause degradation of the valve train 108.

Referring to FIG. 2, the valve cover assembly 200 includes a housing 202. The housing 202 defines an interior space 204 therewithin. The housing 202 is configured to receive a portion of the valve train 108 of the engine 100. For example, the housing 202 may receive the push rods, an injector (not shown), a rocker shaft 118, and the rocker arm 116. The housing 202 has a top closed end 206. The top closed end 206 of the housing 202 may include an opening 208 to receive high pressure fuel lines for connection to the injector, and allowing passage of fuel through the fuel lines. Further, the housing 202 may also include an aperture 210. The aperture 210 is configured to receive a central bolt 212 therein. The central bolt 212 is configured to couple the housing 202 with the cylinder head 102.

The housing 202 has a bottom open end 214. The bottom open end 214 of the housing 202 is coupled to a deck 216 using fasteners 218. The deck 216 is in turn coupled to a top surface 217 of the cylinder head 102 using fasteners 220. The bottom open end 214 may include a sealing surface (not shown). In order to seal the housing 202 with the deck 216, the sealing surface at the bottom open end 214 may be provided with a sealing member (not shown), such as, an O-ring. The sealing member, the fasteners 218, and the central bolt 212 together couple the valve cover assembly 200 to the deck 216.

It should be noted that the valve train 108 may have to be serviced or some components of the valve train 108 may have to be replaced during an operation of the engine 100, based on system requirements. Thus, the valve train 108 may have to be periodically accessed by personnel to perform maintenance work. It may be time consuming for the personnel to remove and re-install the valve cover assembly 200 for maintenance.

In order to access the valve train 108 present inside the housing 202 without completely dismantling the housing 202 from the deck 216, the housing 202 of the valve cover assembly 200 includes a front window 222. Referring to FIGS. 1 and 2, the front window 222 may provide access to the valve train 108. For example, the front window 222 may allow the personnel to adjust or reset periodically a valve lash between the rocker arm 116 and the valve stem 112, for proper functioning of the engine 100. The front window 222 may also allow the personnel to access and perform maintenance of the valves 110, remove/replace an injector crab (not shown) of the injector, or access wiring associated with the valve train 108.

The front window 222 is provided on the housing 202. More particularly, the front window 222 is provided partially on a top wall 224 of the housing 202 and partially on a front facing wall 226 of the housing 202. In the illustrated embodiment, the front window 222 has a trapezoidal shape. Alternatively, the front window 222 may be square or rectangular shaped. Dimensions of the front window 222 are decided such that the personnel may conveniently access the components of the valve train 108 therethrough.

The valve cover assembly 200 includes a front cover 228. The front cover 228 is configured to be releasably coupled to the front window 222. The front cover 228 is configured to provide selective access to the valve train 108 present inside the housing 202. Dimensions, such as a perimeter of the front cover 228 is decided based on a perimeter of the corresponding front window 222. Further, a shape of the front cover 228 is decided such that the front cover 228 does not include any protruding portions, and conforms to a contour of the housing 202. Referring to FIG. 1, in embodiment example, an outer facing surface 230 of the front cover 228 may have a flat profile.

Referring to FIG. 2, in another embodiment, the shape of the front cover 228 is provided such that, when the front cover 228 is coupled with the front window 222, the outer facing surface 230 of the front cover 228 co-operates with walls 224, 226 of the housing 202. More particularly, the shape of the front cover 228 is decided such that the outer facing surface 230 of the front cover 228 flushes with the top wall 224 and the front facing wall 226 of the housing 202, and does not protrude therefrom.

The front cover 228 is releasably coupled to the front window 222. The front cover 228 is coupled to the front window 222 using mechanical fasteners 232. In another example, a sealing member (not shown) such as an 0-ring may be provided between an interface of the front window 222 and the front cover 228 respectively, for a coupling thereof. It should be noted that any other joining process may be used to releasably couple the front cover 228 with the front window 222, without limiting the scope of the present disclosure.

Additionally, in order to access still other components of the valve train 108 located proximate to a side facing wall 234 a side window 238 is provided on the housing 202. The side window 238 may allow the personnel to remove or replace the valves 110 and/or the rocker shaft 118. For example, the side window 238 may allow the personnel to access one or more bolts 120 associated with the rocker shaft 118. In another example, the side window 238 may also allow the personnel to reposition the push rods therethrough.

The side window 238 is provided partially on the top wall 224 and the side facing wall 234 of the housing 202. The side window 238 extends along the side facing wall 234 of the housing 202. In one embodiment, the side window 238 may include a flat sealing surface 240. The side window 238 has an elongate shape. For example, the side window 238 may have an oblong shape. The shape and dimensions of the side window 238 is decided such that the personnel may conveniently access the valve train 108 present inside the housing 202, through the side window 238.

The valve cover assembly 200 also includes a side cover 242. The side cover 242 is releasably coupled to the side window 238. The side cover 242 extends along a length of the side facing wall 234 of the housing 202. The side cover 242 is configured to provide selective access to a portion of the valve train 108 present inside the housing 202. The side cover 242 may optionally include a flat sealing surface 244. The side cover 242 may have an elongate shape, corresponding to the shape of the side window 238. In one example, the side cover 242 has an oblong shape.

As shown in the accompanying figures, an outer facing surface 246 of the side cover 242 may have a concave shape. Alternatively, the side cover 242 may have a planar shape. The shape of the side cover 242 is decided such that when the side cover 242 is coupled to the side window 238, the side cover 242 conforms to the contours of the housing 202, and does not create any interference with other engine components.

The side cover 242 is releasably coupled to the side window 238. A sealing element 248 is provided between the sealing surfaces 240, 242 of the side window 238 and the side cover 242 respectively. In one example, the sealing element 248 may include an 0-ring. The sealing element 248 is configured to seal the side cover 242 with the side window 238. The sealing surfaces 240, 242 of the side window 238 and the side cover 242 respectively may include grooves (not shown) to accommodate the sealing element 248.

The side cover 242 also includes one or more apertures 250 formed thereon. The aperture 250 is configured to receive a mechanical fastener 252 therethrough. The mechanical fastener 252 is configured to couple the side cover 242 with the side window 238. In the illustrated embodiment, the side cover 242 includes a pair of apertures 250, to receive a pair of mechanical fasteners 252 therethrough.

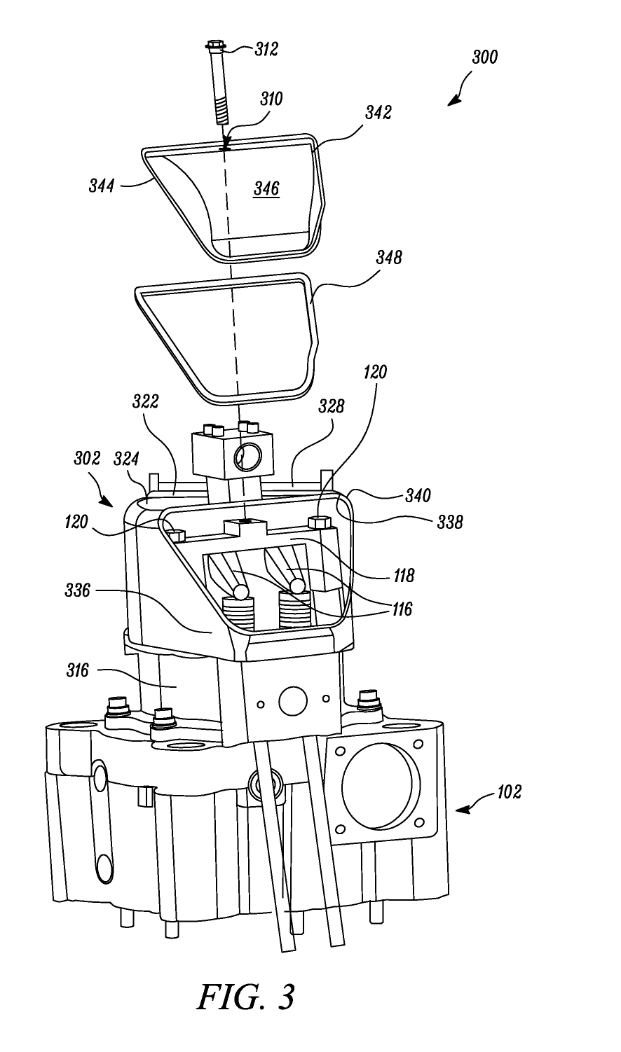

FIG. 3 illustrates a valve cover assembly 300, according to one embodiment of the present disclosure. The valve cover assembly 300 includes a housing 302, a front window 322, and a front cover 328 similar to shape and dimensions of the housing 202, the front window 222, and the front cover 228 of the valve cover assembly 200 explained in connection with FIG. 2.

The valve cover assembly 300 includes a rear window 338. The rear window 338 allows the personnel to access the components of the valve train 108 positioned adjacent to a rear facing wall 336 of the housing 302. For example, the rear window 338 may allow the personnel to access both the bolts 120 associated with the rocker shaft 118. Further, the rear window 338 may also provide the personnel direct access to both the push rods associated with the valve train 108 for servicing or replacement purposes. The rear window 338 may provide access for removal or replacement of the valves 110 and/or the rocker shaft 118.

The rear window 338 may be positioned diametrically opposite to the front window 322 on the housing 302. The rear window 338 is provided partially on a top wall 324 and the rear facing wall 336 of the housing 302. In the illustrated embodiment, the rear window 338 has a trapezoidal shape. Alternatively, the rear window 338 may be square or rectangular shaped. Dimensions of the rear window 338 are decided such that the personnel may conveniently access the components of the valve train 108 therethrough. Additionally or optionally, the rear window 338 may include a flat sealing surface 340.

The valve cover assembly 300 includes a rear cover 342. The rear cover 342 is releasably coupled to the rear window 338. The rear cover 342 is configured to provide selective access to the components of the valve train 108 present inside the housing 302. The rear cover 342 may also include a flat sealing surface 344 to mate with the flat sealing surface 340 of the rear window 338.

The rear cover 342 is trapezoidal in shape, corresponding to the shape of the rear window 338. Further, an outer facing surface 346 of the rear cover 342 may have a planar profile. Alternatively, the outer facing surface 346 may have a concave profile. The shape of the rear cover 342 is decided such that, when the rear cover 342 is coupled to the rear window 338, the rear cover 342 conforms to the contours of the housing 302, and does not create any interference with other engine components.

Further, the rear cover 342 is releasably coupled to the rear window 338. A sealing element 348 is provided between the sealing surfaces 340, 344 of the rear window 338 and the rear cover 342 respectively. In one example, the sealing element 348 may include an O-ring. The sealing element 348 is configured to seal the rear cover 342 with the rear window 338. In one example, the sealing surfaces 340, 344 of the rear window 338 and the rear cover 342 respectively may include grooves (not shown) to accommodate the sealing element 348.

The rear cover 342 also includes one or more apertures 310 formed on the rear cover 342. The apertures 310 may receive a central bolt 312 therethrough. The central bolt 312 is configured to couple the rear cover 342, and also the housing 302 with a deck 316.

Although FIGS. 2 and 3 illustrate the front and side windows 222, 238 and the front and rear windows 322, 338 being provided on the respective housings 202, 302, the present disclosure is not limited to that described herein. Any other combinations of providing the windows 222, 322, 238, 338 for accessing the components of the valve train 108 also lie within the scope of the present disclosure. For example, the housing may include the side and rear windows. Alternatively, the housing may include the front, rear and side windows.

The dimensions of the front windows 222, 322, the side window 238, and the rear window 338 shown in FIGS. 2 and 3 are exemplary, and may vary based on system requirements, without limiting the scope of the present disclosure. Also, the housing 202, 302, the front cover 228, 328, the side cover 242, and the rear cover 342 may be made of any metal or polymer known in the art. Further, the central bolt 212, 312 and the fasteners 218, 220, 232, 252 may embody any known fastening element such as bolt, screw, pin, rivet, and the like. Further, a length of the central bolt 212, 312 and the fasteners 218, 220, 232, 252 may vary as per system requirements, without limiting the scope of the present disclosure.

### INDUSTRIAL APPLICABILITY

The valve cover assembly 200, 300 includes the side window 238 and the rear window 338 to access the components of the valve train 108 that are not easily accessible from the respective front windows 222, 322. Further, each of the side window 238 and the rear window 338 respectively receive the side cover 242 and the rear cover 342. The side and rear covers 242, 342 provide selective access to the components of the valve train 108 present inside the housing 202, 302, through the side window 238 and the rear window 338 respectively.

The side and rear windows 238, 338 provide quick and easy access to the components of the valve train 108 present within the housing 202, 302, without disassembling the housing 202, 302 and disturbing the high pressure fuel lines connected to the injector. Therefore, time associated with inspection and maintenance of the valve train 108 may be reduced. Further, an interface between each of the side cover 242 and the side window 238 and the rear cover 342 and the rear window 338 is resistant to leakage, thereby assuring negligible or no leakages through these interfaces.

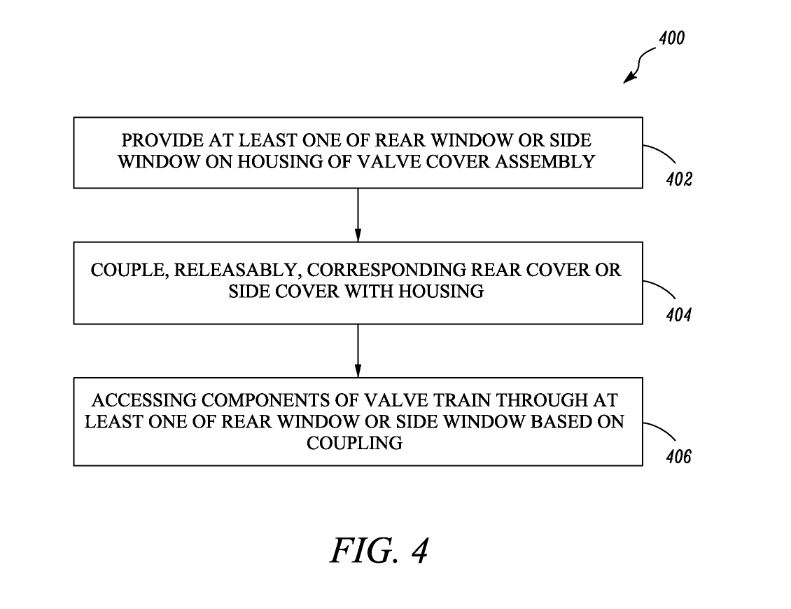

FIG. 4 is a method 400 of servicing of the valve train 108 of the engine 100. At step 402, the side window 238 or the rear window 338 or both are provided on the housing 202, 302 of the respective valve cover assembly 200, 300. Further, the front window 222, 322 is also provided on the housing 202, 302. The front cover 228, 328 is releasably coupled to the front window 222, 322 of the housing 202, 302.

At step 404, the corresponding side cover 242 or the rear cover 342 is releasably coupled with the housing 202, 302. The flat sealing surface 244, 344 of at least one of the side cover 242 or the rear cover 342 is aligned with the corresponding flat sealing surfaces 240, 340 of the side window 238 or the rear window 338 respectively. Further, the sealing element 248, 348 is provided between the side window 238 or the rear window 338 and the corresponding side cover 242 or the rear cover 342. At step 406, the components of the valve train 108 are accessed through the respective side window 238 or the rear window 338 based on the coupling.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof. cm What is claimed is:

1. A valve cover assembly for an engine, the valve cover assembly comprising:
a housing defining an interior space therewithin, the housing configured to receive a portion of a valve train of the engine, the housing having a top closed end and a bottom open end, wherein the bottom open end is coupled to a surface of the engine;
a front window provided on a top wall and a front facing wall of the housing;
a front cover releasably coupled to the front window, the front cover configured to provide selective access to components of the valve train present inside the housing;
a side window provided on the top wall and a side facing wall of the housing; and
a side cover releasably coupled to the side window, the side cover configured to provide selective access to the components of the valve train present inside the housing.

2. The valve cover assembly of claim 1 further comprising a flat sealing surface provided at the side window and the side cover respectively.

3. The valve cover assembly of claim 1 further comprising a sealing element provided between the side cover and the housing.

4. The valve cover assembly of claim 1, wherein the side window and the side cover have an elongate shape.

5. The valve cover assembly of claim 1, wherein an outer facing surface of the side cover has a concave shape.

6. The valve cover assembly of claim 1, wherein the side window and the side cover extend along the side facing wall of the housing.

7. The valve cover assembly of claim 1, wherein at least one aperture is formed on the side cover, the at least one aperture configured to receive a mechanical fastener therethrough.

8. A valve cover assembly for an engine, the valve cover assembly comprising:
a housing defining an interior space therewithin, the housing configured to receive a portion of a valve train of the engine, the housing having a top closed end and a bottom open end, wherein the bottom open end is coupled to a surface of the engine;
a front window provided on a top wall and a front facing wall of the housing;
a front cover releasably coupled to the front window, the front cover configured to provide selective access to components of the valve train present inside the housing;
a rear window provided on the top wall and a rear facing wall of the housing; and
a rear cover releasably coupled to the rear window, the rear cover configured to provide selective access to the components of the valve train present inside the housing.

9. The valve cover assembly of claim 9 further comprising a flat sealing surface provided at the rear window and the rear cover respectively.

10. The valve cover assembly of claim 9 further comprising a sealing element provided between the rear cover and the housing.

11. The valve cover assembly of claim 9, wherein the rear window and the rear cover have a trapezoidal shape.

12. The valve cover assembly of claim 9, wherein an outer facing surface of the rear cover has a concave shape.

13. The valve cover assembly of claim 9, wherein the rear window is positioned diametrically opposite to the front window.

14. The valve cover assembly of claim 9, wherein at least one aperture is formed on the rear cover, the at least one aperture configured to receive a mechanical fastener therethrough.

15. A method for servicing of a valve train of an engine, the method comprising:
providing at least one of a rear window or a side window on a housing of a valve cover assembly;
coupling, releasably, a corresponding rear cover or a side cover with the housing; and
accessing the components of the valve train through the at least one of the rear window or the side window based on the coupling.

16. The method of claim 15 further comprising:
providing a sealing element between at least one of the rear window or the side window and the corresponding rear cover or the side cover.

17. The method of claim 15 further comprising:
providing, a front window on the housing; and
coupling, releasably, a front cover to the front window.

18. The method of claim 15 further comprising:
aligning a flat sealing surface of at least one of the rear cover or the side cover with the corresponding rear window or the side window.
